(19) United States
(12) Patent Application Publication
(10) Pub. No.: US 2026/0025633 A1
(43) Pub. Date: Jan. 22, 2026

(54) METHOD, APPARATUS, AND SYSTEM FOR TESTING AUDIO SPATIAL PERCEPTION OF HEAD-MOUNTED DISPLAY DEVICE

(71) Applicant: GOERTEK TECHNOLOGY CO., LTD., Qingdao (CN)

(72) Inventors: Hongmei LI, Qingdao (CN); Shichao XU, Qingdao (CN)

(21) Appl. No.: 19/252,030

(22) Filed: Jun. 27, 2025

Related U.S. Application Data
(63) Continuation of application No. PCT/CN2023/124812, filed on Oct. 16, 2023.

(30) Foreign Application Priority Data
Jun. 29, 2023 (CN) 202310788577.2

(51) Int. Cl. H04S 7/00

(52) U.S. Cl. CPC H04S 7/304; H04S 2420/01

(57) ABSTRACT

Disclosed are a method, an apparatus and a system for testing audio spatial perception of a head-mounted display device. The method includes: controlling a virtual sound source to send an excitation signal at a preset spatial orientation, and playing the excitation signal by a speaker of a head-mounted display device, to obtain signals respectively and simultaneously received by left and right ears of a simulated person; calculating a plurality of spatial sound effect parameters of the virtual sound source according to the signals respectively and simultaneously received by left and right ears of the simulated person; determining whether the plurality of spatial sound effect parameters are within respective preset standard value ranges corresponding to the preset spatial orientation.

### CROSS-REFERENCE TO RELATED APPLICATIONS

The present application is a continuation application of International Application No. PCT/CN2023/124812, filed on Oct. 16, 2023, which claims priority to Chinese patent application No. 202310788577.2, entitled in “METHOD, APPARATUS, AND SYSTEM FOR TESTING AUDIO SPATIAL PERCEPTION OF HEAD-MOUNTED DISPLAY DEVICE” and filed on Jun. 29, 2023. The disclosures of the above-mentioned applications are incorporated herein by reference in their entireties.

### TECHNICAL FIELD

The present application relates to the technical field of virtual spatial sound, and in particular to a method, an apparatus, and a system for testing audio spatial perception of a head-mounted display device.

### BACKGROUND

Since the concept of the metaverse became popular, virtual reality (VR) products, augmented reality (AR) products, mixed reality (MR) products, etc. have emerged in an endless stream from domestic to foreign countries, from large companies to small companies, from mature enterprises to start-ups, setting off a wave of industrial waves. To make people fully immersed in VR/AR/MR content, both picture quality and sound effects are indispensable. From refresh rate to head tracking delay, from field of view to resolution, the fineness of VR/AR/MR images and the comfort of viewing are constantly raised by new technologies. But it is far from enough to feel immersive visually. Even if the VR/AR/MR content images are so realistic that they are indistinguishable from the real thing, if the sound effects are not good, it is inevitable that there will be a sense of drama. Therefore, VR/AR/MR must also be “sound” immersive, with an accurate sense of direction and distance, and be no different from the reaction of people after hearing the sound in reality, so that users can truly maintain a high degree of immersion.

However, the audio spatial perception test of head-mounted display devices for VR/AR/MR products is currently based more on subjective feelings, and there is no objective testing method.

### SUMMARY

The embodiments of the present application provide a method, an apparatus and a system for testing audio spatial perception of a head-mounted display device, which are configured to solve the bottleneck that the audio spatial perception of the head-mounted display device can only be subjectively felt but not objectively tested.

According to a first aspect of the present application, a method for testing audio spatial perception of a head-mounted display device is provided, and the method includes:
wearing the head-mounted display device to be tested normally on a head of a simulated person, and controlling a virtual sound source by software instructions to be located in different preset spatial orientations in sequence;
controlling the virtual sound source to send an excitation signal at the preset spatial orientation and a speaker of the head-mounted display device to play the excitation signal, to obtain signals simultaneously received by left and right ears of the simulated person;
calculating multiple spatial sound effect parameters of the virtual sound source according to the signals simultaneously received by the left and right ears of the simulated person;
the spatial sound effect parameters include a interaural time difference, a interaural level difference and a spectrum curve after normalization of left ear/right ear transfer function; and
determining whether the calculated multiple spatial sound effect parameters are within respective preset standard value ranges corresponding to the preset spatial orientation; in response to that all the spatial sound effect parameters are within the respective preset standard value ranges, determining that a spatial sound effect test of the virtual sound source at the preset spatial orientation is qualified; in response to that a certain spatial sound effect parameter is not within the preset standard value range, determining that the spatial sound effect test of the virtual sound source at the preset spatial orientation is unqualified.

According to a second aspect of the present application, An apparatus for testing audio spatial perception of a head-mounted display device is provided, and the apparatus includes:
a spatial orientation control unit, configured to normally wear the head-mounted display device to be tested on a head of a simulated person, and control a virtual sound source to be located in different preset spatial orientations in sequence through software instructions;
a received signal acquisition unit, configured to control the virtual sound source to send an excitation signal at the preset spatial orientation and the speaker of the head-mounted display device to play the excitation signal, so as to acquire signals simultaneously received by the left and right ears of the simulated person;
a spatial sound effect parameter calculation unit, configured to calculate a plurality of spatial sound effect parameters of the virtual sound source according to the signals simultaneously received by the left and right ears of the simulated person; the spatial sound effect parameters include a interaural time difference, a interaural level difference and a spectrum curve after normalization of left ear/right ear transfer function; and
a spatial sound effect parameter qualification determination unit, configured to determine whether the calculated multiple spatial sound effect parameters are within respective preset standard value ranges corresponding to the preset spatial orientation; in response to that all the spatial sound effect parameters are within the respective preset standard value ranges, determining that a spatial sound effect test of the virtual sound source at the preset spatial orientation is qualified; in response to that a certain spatial sound effect parameter is not within the preset standard value range, determining that the spatial sound effect test of the virtual sound source at the preset spatial orientation is unqualified.

According to a third aspect of the present application, a system for testing audio spatial perception of a head-mounted display device is provided, and the system includes:
a simulated person;
a speaker;
a control console; and
a head-mounted display device to be tested;
the control console uses the method for testing audio spatial perception of the head-mounted display device to perform a spatial sound effect test on the head-mounted display device to be tested.

The beneficial effects of the embodiments of the present application are:

Each embodiment of the present application controls the virtual sound source to be located in different preset spatial orientations in sequence through software instructions, controls the virtual sound source to send an excitation signal at the preset spatial orientation, and plays the excitation signal through the speaker of the head-mounted display device, the purpose of which is to obtain the signals simultaneously received by the left and right ears of the simulated person, so as to calculate the multiple spatial sound effect parameters of the virtual sound source according to the signals simultaneously received by the left and right ears of the simulated person, and then determining whether the calculated multiple spatial sound effect parameters of the virtual sound source are within the respective preset standard value ranges corresponding to the preset spatial orientation. When judging, if all spatial sound effect parameters are within their respective preset standard value ranges, the spatial sound effect test of the virtual sound source at the preset spatial orientation is determined to be qualified; if a certain spatial sound effect parameter is not within the preset standard value range, the spatial sound effect test of the virtual sound source at the preset spatial orientation is determined to be unqualified. Since the qualification of the spatial sound effect test is based on whether multiple spatial sound effect parameters are within the corresponding respective preset standard value ranges, the technical solutions of the various embodiments of the present application realize an objective test of the audio spatial perception of the head-mounted display device, solving the bottleneck of only subjective perception without objective testing at present, and the obtained test results are more real and reliable.

### BRIEF DESCRIPTION OF THE DRAWINGS

In order to more clearly illustrate the embodiments of the present application or the technical solutions in the related art, the drawings required for use in the embodiments or the description of the related art will be briefly introduced below. Obviously, the drawings described below are only some embodiments of the present application. For those skilled in the art, other drawings can be obtained based on the structures shown in these drawings without paying creative work.

FIG. 1 is a schematic diagram of a space sphere, where the center of the sphere is the center of the head of a simulated person or user.

FIG. 2 is a schematic diagram showing a virtual sound source at different directional angles.

FIG. 3 is a schematic diagram showing a virtual sound source at different horizontal angles.

FIG. 4 is a schematic flow chart of a method for testing audio spatial perception of a head-mounted display device according to an embodiment of the present application.

FIG. 5 is a schematic diagram of a logical relationship between a received signal and an excitation signal.

FIG. 6A to FIG. 6D are schematic diagrams comparing left ear/right ear transfer functions when the horizontal angle of the test point is 0 degrees and the azimuth angles are 0 degrees, 30 degrees, 60 degrees and 90 degrees respectively, according to an embodiment of the present application.

FIG. 7A shows the time difference Δτ between the left and right ears obtained in the H000E000 scenario corresponding to FIG. 6A, and FIG. 7B shows the time difference Δτ between the left and right ears obtained in the H000E090 scenario corresponding to FIG. 6D.

FIG. 8A shows the frequency response FR of the left and right ears obtained in the H000E000 scenario corresponding to FIG. 6A, and FIG. 8B shows the frequency response FR of the left and right ears obtained in the H000E090 scenario corresponding to FIG. 6D.

FIG. 9 shows the normalized spectrum curves of the right ear transfer function in two scenarios, H000E000 corresponding to FIG. 6A and H000E090 corresponding to FIG. 6D.

FIG. 10 is a schematic diagram showing a structure of an apparatus for testing audio spatial perception of a head-mounted display device according to an embodiment of the present application.

FIG. 11 is a schematic diagram showing a structure of a system for testing audio spatial perception of a head-mounted display device according to an embodiment of the present application.

### DETAILED DESCRIPTION OF THE EMBODIMENTS

The following will describe the embodiments of the present application in more detail with reference to the accompanying drawings. These embodiments are provided to enable a more thorough understanding of the present application and to fully convey the scope of the present application to those skilled in the art. Although the exemplary embodiments of the present application are shown in the accompanying drawings, it should be understood that the present application can be implemented in various forms and should not be limited to the embodiments described herein.

Generally speaking, there are three important factors that affect interaural auditory spatial localization: interaural time difference (ITD), interaural level difference (ILD) and spectral effect.
(1) ITD: there is a time difference between the transmission from the sound source to the left and right ears of a person, and this time difference is the interaural time difference, which is an important factor in locating the direction of the sound source. When the sound source is located in the median vertical plane of the head, the distance from it to both ears is equal; but when the sound source deviates from the median vertical plane, the distance from it to both ears will be different, so there is an ITD between the sound wave transmission to both ears. This change will be detected by the ears, so ITD is a very important factor in the ears to achieve positioning.
(2) ILD: when a point sound source deviates from the median vertical plane of the head, the head will cast a shadow and scatter the sound waves (especially in the high-frequency part). The sound pressure at the ear on the opposite side of the sound source will be attenuated, while the sound pressure at the ear on the same side as the sound source will be increased to a certain extent, thus forming a interaural level difference. For sound waves with relatively high frequencies, the wavelength of the sound wave is smaller than the head size. When the sound source is not on the median vertical line connecting the two ears, the sound wave is shielded by the head and cannot be diffracted to the ear canal farther away, resulting in a difference in the sound level reaching the two ears. The more the sound source deviates from the median vertical line, or the higher the frequency, the greater the sound level difference between the two ears. The greater the sound level difference, the stronger the localization ability. At the same time, there are different sound level difference manifestations for different frequencies. The sound level difference between the two ears caused by low-frequency sound sources changes less with the azimuth of the sound source, that is, the two ears have poor localization ability for low-frequency sounds. As the frequency of the sound source increases, the sound level difference between the two ears increases with the change of azimuth, and the localization ability of the sound gradually increases.
(3) Spectral effect: The essence of spectral effect is that the auricle effect changes the spectral characteristics of sounds in different spatial directions. The change in spectral characteristics is mainly for high-frequency signals. Since high-frequency signals have short wavelengths, the reflected waves reflected from the auricle to the ear canal will add in phase, subtract in opposite phases, or even cancel each other out, forming peaks and valleys on the spectrum, which is the effect of the auricle on high-frequency sound waves. Based on the spectral effect, the spectrum curve of the left ear/right ear transfer function can be configured to locate the sense of space.

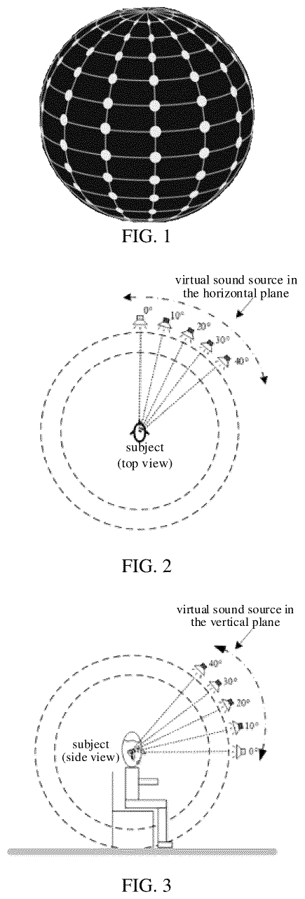

FIG. 1 shows a schematic diagram of a space sphere, where the center of the sphere is the center of the head of a simulated person or user. FIG. 2 shows a schematic diagram of a virtual sound source at different azimuth angles. FIG. 3 shows a schematic diagram of a virtual sound source at different horizontal angles. For a head-mounted display device, the distance of the virtual sound source relative to the center of the head of the simulated person or user is the same, which is the radius of the sphere, and only the horizontal angle and azimuth angle change.

Before starting the objective test of the audio spatial perception of the head-mounted display device of the present application, it is necessary to set up a test environment in an anechoic room in advance, and the test equipment includes a simulated person and a speaker.

The test process is to place the speakers one by one at the test points corresponding to the preset spatial orientation, control the speakers to send excitation signals at the test points, obtain the signals received simultaneously by the left and right ears of the simulated person, so as to pre-calculate each of standard value ranges of multiple spatial sound effect parameters corresponding to each preset spatial orientation according to the signals received simultaneously by the left and right ears of the simulated person at the test points. The test points are selected according to the test requirements.

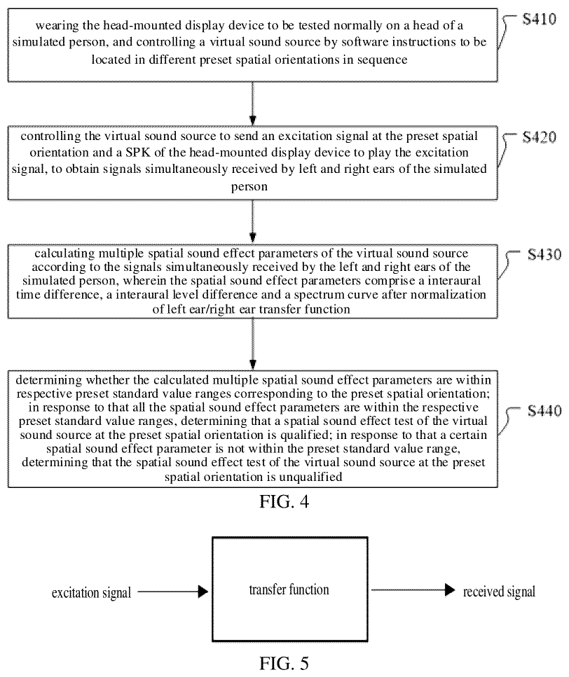

FIG. 4 is a flow chart of a method for testing the audio spatial perception of a head-mounted display device according to an embodiment of the present application. Referring to FIG. 4, the method of the present application includes the following steps S410 to S450:

Step S410: wearing the head-mounted display device to be tested normally on a head of a simulated person, and controlling a virtual sound source by software instructions to be located in different preset spatial orientations in sequence.

The spatial orientation information of the virtual sound source includes distance, horizontal angle, and azimuth angle.

The test distance is generally selected based on actual test needs. Considering that the spatial audio of head-mounted display devices is often a near sound field, the near-field distance (the radius of the near-field sphere surrounding the listener's head) is usually defined as approximately 0.5-1.0 m.

Step S420, controlling the virtual sound source to send an excitation signal at the preset spatial orientation and a speaker of the head-mounted display device to play the excitation signal, to obtain signals simultaneously received by left and right ears of the simulated person.

Microphones may be respectively arranged at the left and right ears of the simulated person, and signals simultaneously received by the left and right ears of the simulated person may be obtained according to the signals collected by the microphones.

FIG. 5 shows a schematic diagram of a logical relationship between a received signal and an excitation signal. As shown in FIG. 5, the acoustic transfer path between the excitation signal and the received signal is represented by a transfer function.

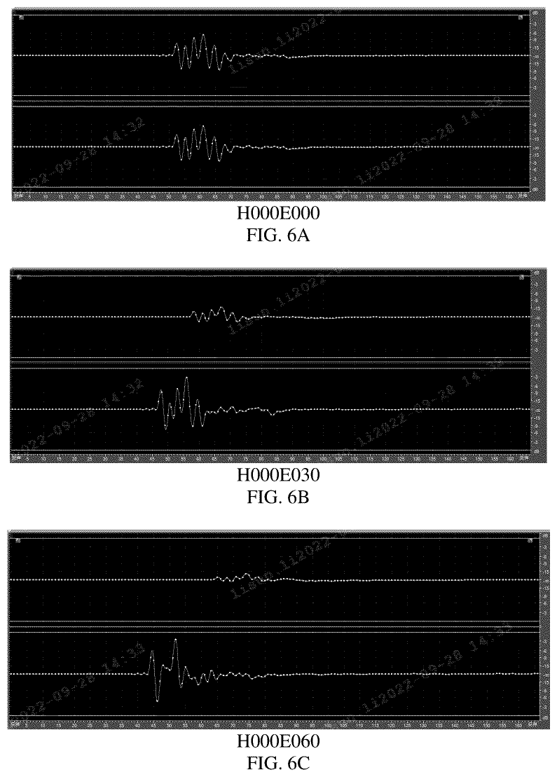

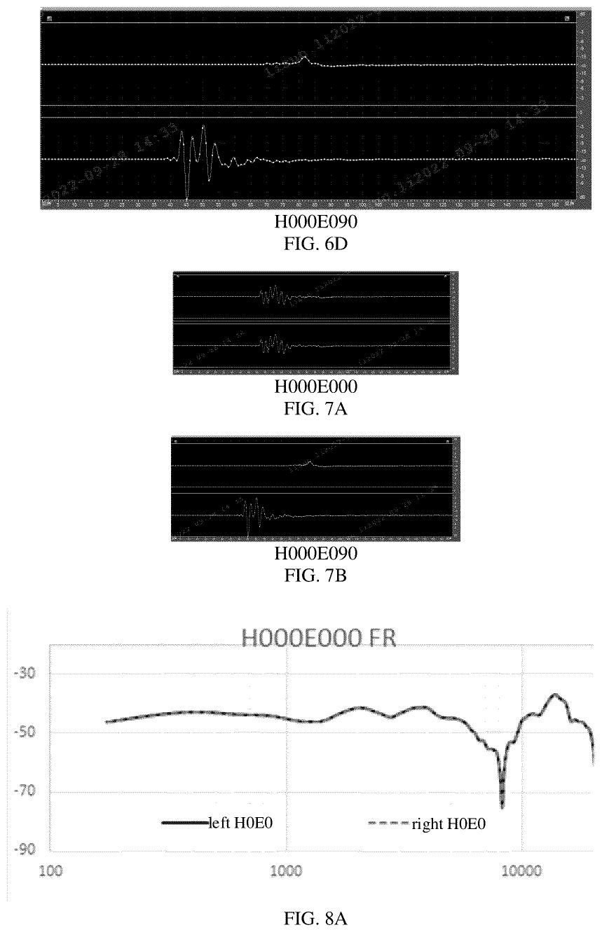

FIG. 6A to FIG. 6D show a schematic diagram of the comparison of the left ear/right ear transfer functions when the horizontal angle of the test point of an embodiment of the present application is 0 degrees, and the azimuth angles are 0 degrees, 30 degrees, 60 degrees and 90 degrees respectively. Among them, the upper track is the left channel (corresponding to the left ear), the lower track is the right channel (corresponding to the right ear). H000E000 indicates that the horizontal angle is 0 degrees and the azimuth angle is 0 degrees, H000E030 indicates that the horizontal angle is 0 degrees and the azimuth angle is 30 degrees, H000E060 indicates that the horizontal angle is 0 degrees and the azimuth angle is 60 degrees, and H000E090 indicates that the horizontal angle is 0 degrees and the azimuth angle is 90 degrees. According to the comparison of the upper and lower tracks of FIG. 6A to FIG. 6D, it can be seen that the sound source plays the excitation signal at different test points. Since the signals received by the left and right ears are different, the transfer functions of the left and right ears are also different.

Step S430, calculating multiple spatial sound effect parameters of the virtual sound source according to the signals simultaneously received by the left and right ears of the simulated person; the spatial sound effect parameters include a interaural time difference, a interaural level difference and a spectrum curve after normalization of left ear/right ear transfer function.

In an embodiment, the interaural time difference of the virtual sound source is calculated based on the signals simultaneously received by the left and right ears of the simulated person, including: convolving the signals simultaneously received by the left and right ears of the simulated person with the excitation signal respectively to obtain the time τ when the excitation signal arrives at the left and right ears of the simulated person respectively; and obtaining the interaural time difference of the virtual sound source based on the time difference Δτ between the left and right ears.

FIG. 7A shows the time difference Δτ between the left and right ears in the H000E000 scenario corresponding to FIG. 6A, and FIG. 7B shows the time difference Δτ between the left and right ears in the H000E090 scenario corresponding to FIG. 6D. By comparison, we can see that in the case of H000E000, the time difference between the left and right ears Δτ≈0, while in the case of H000E090, the time difference between the left and right ears Δτ≈0.68 ms. It can be seen that there are differences in the interaural time difference under different spatial orientation scenarios.

In an embodiment, the interaural level difference of the virtual sound source is calculated based on the signals simultaneously received by the left and right ears of the simulated person, including: performing fast Fourier transformation (FFT) on the signals simultaneously received by the left and right ears of the simulated person to convert them into the frequency domain to obtain the frequency responses (FR) of the left and right ears; and obtaining the interaural level difference of the virtual sound source based on the difference ΔFR between the frequency responses of the left and right ears.

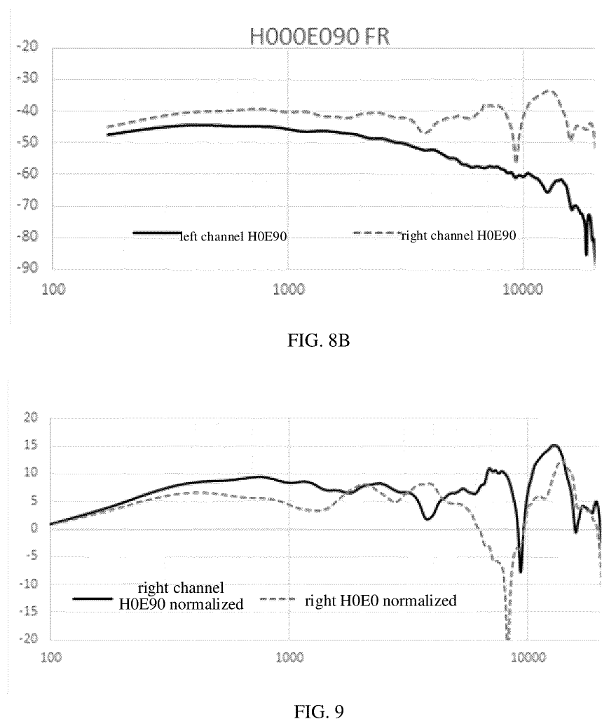

FIG. 8A shows the FR of the left and right ears in the H000E000 scenario corresponding to FIG. 6A, and FIG. 8B shows the FR of the left and right ears in the H000E090 scenario corresponding to FIG. 6D. By comparing FIG. 8A and FIG. 8B, it can be seen that in the H000E000 scenario, the FR curves of the left and right ears basically overlap, while in the H000E090 scenario, there is a significant difference between the FR curves of the left and right ears. It can be seen that there are differences in interaural level differences in different spatial orientation scenarios.

In an embodiment, the normalized spectrum curve of the left-right ear transfer function of the virtual sound source is calculated based on the signals simultaneously received by the left and right ears of the simulated person, including: performing FFT transformation on the excitation signal and the signals simultaneously received by the left and right ears of the simulated person to convert them into the frequency domain; dividing the received signals of the left and right ears by the excitation signal in the frequency domain to obtain the spectrum curve of the left-right ear transfer function; and normalizing the spectrum curve of the left-right ear transfer function at a low frequency point to obtain the normalized spectrum curve of the left-right ear transfer function of the virtual sound source.

In order to facilitate comparison with the standard value range, the obtained spectrum curves of the left ear/right ear transfer functions need to be normalized at low frequency points to obtain the normalized spectrum curves of the left ear/right ear transfer functions of the virtual sound source.

FIG. 9 shows the normalized spectrum curves of the right ear transfer function in two scenarios, H000E000 in FIG. 6A and H000E090 in FIG. 6D. As can be seen from FIG. 9, in different spatial orientation scenarios of the virtual sound source, the normalized spectrum curves of the transfer function of the same side channel are still very different, so the audio spatial perception can be judged based on the spectrum curves of the left ear/right ear transfer functions. Since the left and right ear positions are different, it is also necessary to judge the normalized spectrum curves of the left ear/right ear transfer functions separately.

Step S440, determining whether the calculated multiple spatial sound effect parameters are within respective preset standard value ranges corresponding to the preset spatial orientation; in response to that all the spatial sound effect parameters are within the respective preset standard value ranges, determining that a spatial sound effect test of the virtual sound source at the preset spatial orientation is qualified; in response to that a certain spatial sound effect parameter is not within the preset standard value range, determining that the spatial sound effect test of the virtual sound source at the preset spatial orientation is unqualified.

The specific judgment process is as follows:
The first step is to find the standard value range of the interaural time difference, the standard value range of the interaural level difference and the standard value range of the spectrum amplitude of the left ear/right ear transfer functions of the virtual sound source at the corresponding preset spatial orientation. Before conducting the spatial sound effect test, the sound quality was obtained by using a simulated person and speakers in a test environment set up in an anechoic room.
The second step is to determine whether the calculated interaural time difference of the virtual sound source is within a preset standard value range of the interaural time difference. If it is within the standard value range, the interaural time difference parameter is determined to be qualified; otherwise, the interaural time difference parameter is determined to be unqualified;
The third step is to determine, frequency by frequency, whether the calculated interaural level difference of the virtual sound source is within a preset standard value range of the interaural level difference. Only when the interaural level differences of all frequency points are within the standard value range, the interaural level difference parameters are determined to be qualified; otherwise the interaural level difference parameters are determined to be unqualified; and
The fourth step is to determine whether the spectrum amplitude of the normalized spectrum curve of the left ear/right ear transfer function of the calculated virtual sound source is within the standard value range of the spectrum amplitude of the left ear/right ear transfer function for each frequency point. Only when the spectrum amplitudes of the left ear/right ear transfer functions of all frequency points are within the standard value range, the spectrum curve parameters of the left ear/right ear transfer functions are determined to be qualified; otherwise, the spectrum curve parameters of the left ear/right ear transfer functions are determined to be unqualified.

It is easy to understand that the above-mentioned second to fourth steps can be judged in parallel or in sequence, and when judging in sequence, the order of the second to fourth steps can be adjusted arbitrarily.

Furthermore, when outputting the result of whether the audio spatial perception test of the head-mounted display device is qualified, the method of the present application further includes:
If the spatial sound effect test of the virtual sound source at a certain preset spatial orientation is unqualified, ending the audio spatial perception test of the head-mounted display device, and outputting a result that the audio spatial perception test of the head-mounted display device is unqualified;
If the spatial sound effect test of the virtual sound source at a preset spatial orientation is qualified, the virtual sound source is controlled to be transformed to another preset spatial orientation through software instructions, and then a new round of testing process is started for the virtual sound source after the spatial position is changed;
If the spatial sound effect test of the virtual sound source at all preset spatial orientation is qualified, the result that the audio spatial perception test of the head-mounted display device is qualified is output.

According to the above steps, it can be known that the qualified test conditions for the audio spatial perception of the head-mounted display device of the present application are not only objective but also quite rigorous. At all preset spatial orientation, the three spatial sound effect parameters of the interaural time difference, the interaural level difference and the spectrum curve after the normalization of the left ear/right ear transfer function are required to be within their respective preset standard value ranges before the qualified result of the audio spatial perception test of the head-mounted display device is output. If at a certain preset spatial orientation, any of the three spatial sound effect parameters of the interaural time difference, the interaural level difference and the spectrum curve after the normalization of the left ear/right ear transfer function is not within the preset standard value range, then the unqualified result of the audio spatial perception test of the head-mounted display device is output.

In summary, the method for testing the audio spatial perception of the head-mounted display device provided by the present application realizes an objective test of the audio spatial perception of the head-mounted display device, because the qualification of the spatial sound effect test is based on whether a plurality of spatial sound effect parameters are within the corresponding respective preset standard value ranges, thereby solving the bottleneck of only subjective perception without objective testing at present. The obtained test results are more real and reliable.

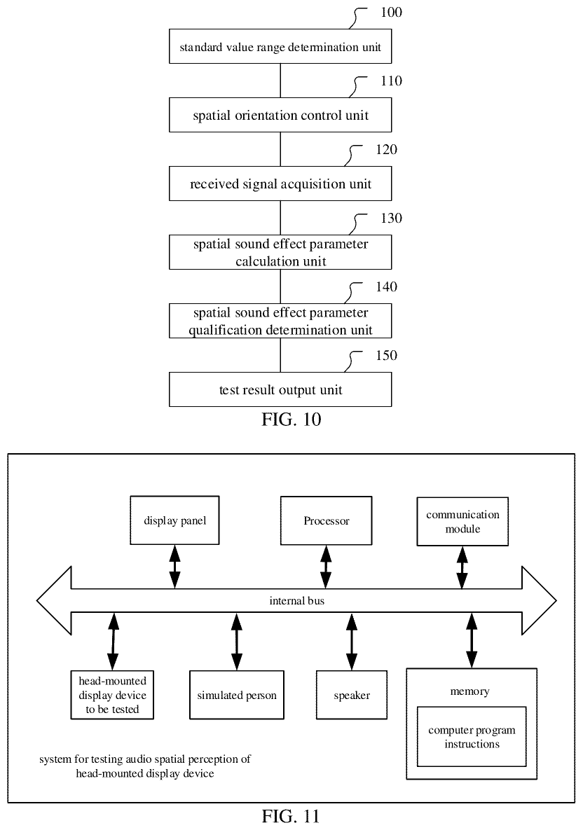

The present application also provides an apparatus for testing the audio spatial perception of a head-mounted display device, which is a technical concept shared with the aforementioned method for testing the audio spatial perception of a head-mounted display device. FIG. 10 shows a schematic diagram of the structure of an apparatus for testing the audio spatial perception of a head-mounted display device according to an embodiment of the present application. Referring to FIG. 10, the apparatus of the present application includes:
a spatial orientation control unit 110, configured to normally wear the head-mounted display device to be tested on a head of a simulated person, and control a virtual sound source to be located in different preset spatial orientations in sequence through software instructions;
a received signal acquisition unit 120, configured to control the virtual sound source to send an excitation signal at the preset spatial orientation and the speaker of the head-mounted display device to play the excitation signal, so as to acquire signals simultaneously received by the left and right ears of the simulated person;
a spatial sound effect parameter calculation unit 130, configured to calculate a plurality of spatial sound effect parameters of the virtual sound source according to the signals simultaneously received by the left and right ears of the simulated person; the spatial sound effect parameters include a interaural time difference, a interaural level difference and a spectrum curve after normalization of left ear/right ear transfer function; and
a spatial sound effect parameter qualification determination unit 140, configured to determine whether the calculated multiple spatial sound effect parameters are within respective preset standard value ranges corresponding to the preset spatial orientation; in response to that all the spatial sound effect parameters are within the respective preset standard value ranges, determining that a spatial sound effect test of the virtual sound source at the preset spatial orientation is qualified; in response to that a certain spatial sound effect parameter is not within the preset standard value range, determining that the spatial sound effect test of the virtual sound source at the preset spatial orientation is unqualified.

Furthermore, when outputting the result of whether the audio spatial perception test of the head-mounted display device is qualified, the apparatus of the present application further includes:
a test result output unit 150, configured for, in response to that the spatial sound effect test of the virtual sound source at a certain preset spatial orientation is unqualified, ending the audio spatial perception test of the head-mounted display device, and outputting a result that the audio spatial perception test of the head-mounted display device is unqualified; in response to that the spatial sound effect test of the virtual sound source at a certain preset spatial orientation is qualified, controlling the virtual sound source to change to another preset spatial orientation through software instructions, and then starting a new spatial sound effect test of the virtual sound source after the spatial position of the virtual sound source is changed; and in response to that the spatial sound effect test of the virtual sound source at all preset spatial orientation is qualified, outputting a result that the audio spatial perception test of the head-mounted display device is qualified.

It can be understood that, still referring to FIG. 10, before the spatial orientation control unit 110, the apparatus of the present application further includes:
a standard value range determination unit 100, configured to, before controlling the virtual sound source to be located at different preset spatial orientations in sequence through software instructions, use a simulated person and a speaker to place the speaker one by one at the test points corresponding to each preset spatial orientation in the anechoic room, control the speaker to send an excitation signal at each test point, and obtain the signal simultaneously received by the left and right ears of the simulated person; and predetermine the standard value ranges of all the spatial sound effect parameters at the preset spatial orientation respectively corresponding signal according to the signal simultaneously received by the left and right ears of the simulated person at each test point.

In some embodiments, the spatial sound effect parameter calculation unit 130 is specifically configured for:
convolving the signals simultaneously received by the left and right ears of the simulated person with the excitation signal respectively to obtain the time τ when the excitation signal reaches the left and right ears of the simulated person respectively, and obtaining the interaural time difference of the virtual sound source according to the time difference Δt between the left and right ears;
performing FFT transformation on the signals simultaneously received by the left and right ears of the simulated person respectively and converting them into the frequency domain, obtaining the FR of the signals received by the left and right ears, and obtaining the interaural level difference of the virtual sound source according to the difference ΔFR between the frequency responses of the signals received by the left and right ears; and
converting the excitation signal and the signals simultaneously received by the left and right ears of the simulated person respectively into the frequency domain by FFT transformation, dividing the received signals of the left and right ears respectively by the excitation signal in the frequency domain to obtain the spectrum curves of the left ear/right ear transfer functions, and normalizing the spectrum curves of the left ear/right ear transfer functions respectively at the low frequency point to obtain the normalized spectrum curves of the left ear/right ear transfer functions of the virtual sound source.

In an embodiment, the spatial sound effect parameter qualification determination unit 140 is specifically configured for:
finding a standard value range of the interaural time difference, a standard value range of the interaural level difference, and a standard value range of a spectrum amplitude of each left ear/right ear transfer function of the virtual sound source at the corresponding preset spatial orientation;
determining whether the calculated interaural time difference of the virtual sound source is within the preset standard value range of the interaural time difference; in response to that the calculated interaural time difference of the virtual sound source is within the preset standard value range of the interaural time difference, determining that the interaural time difference parameter is qualified; in response to that the calculated interaural time difference of the virtual sound source is not within the preset standard value range of the interaural time difference, determining that the interaural time difference parameter is unqualified;
determining whether the calculated interaural level difference of the virtual sound source is within the preset standard value range of the interaural level difference for each frequency point; in response to that the interaural level differences of all frequency points are within the standard value range, determining that the interaural level difference parameter is qualified; in response to that the interaural level difference of one frequency point is not within the standard value range, determining that the interaural level difference parameter is unqualified; and
for the calculated spectrum curve after normalization of the left ear/right ear transfer function of the virtual sound source, determining whether the spectrum amplitude is within the standard value range of the spectrum amplitude of the left ear/right ear transfer function for each frequency point; in response to that the spectrum amplitudes of the left ear/right ear transfer functions of all frequency points are within the standard value range, determining that the spectrum curve parameter of the left ear/right ear transfer function is qualified; in response to that the spectrum amplitude of the left ear/right ear transfer function of one frequency point is not within the standard value range, determining that the spectrum curve parameter of the left ear/right ear transfer function is unqualified.

The implementation process of each unit in the apparatus for testing audio spatial perception of a head-mounted display device of the present application can be referred to the aforementioned method embodiment, and will not be described in detail here.

The present application also provides a system for testing the audio spatial perception of a head-mounted display device, which is a technical concept shared with the aforementioned method and device for testing the audio spatial perception of a head-mounted display device. FIG. 11 shows a schematic diagram of the structure of a system for testing the audio spatial perception of a head-mounted display device according to an embodiment of the present application. Referring to FIG. 10, the testing system of the present application includes a simulated person, a speaker, a control console, and a head-mounted display device to be tested; the control console uses the method for testing the audio spatial perception of the aforementioned head-mounted display device to perform a spatial sound effect test on a head-mounted display device to be tested, and can further output a result of whether the audio spatial perception test of the head-mounted display device is qualified.

At the hardware level, the control console includes a processor, a memory for storing computer program instructions, and a display panel. In addition, the control console may also include a communication module, etc. The entire test system is set up in an anechoic chamber. The various components in the test system can be interconnected through an internal bus, which can be an industry standard architecture (ISA) bus, a peripheral component interconnect (PCI) bus, or an extended industry standard architecture (EISA) bus, etc. The bus can be divided into an address bus, a data bus, a control bus, etc. For ease of representation, only one bidirectional arrow is used in FIG. 11, but it does not mean that there is only one bus or one type of bus.

It should be understood by those skilled in the art that the various embodiments of the present application may be provided as methods, systems, electronic devices or computer program products. Therefore, the present application may take the form of a complete hardware embodiment, a complete software embodiment, or a combination of software and hardware embodiments. Moreover, the present application may take the form of a computer program product implemented on one or more computer-readable storage media (including but not limited to disk storage, CD-ROM, optical storage, etc.) containing a computer program.

It should also be noted that the terms “include”, “comprise” or any other variations thereof are intended to cover non-exclusive inclusion, so that a process, method, commodity or device including a series of elements includes not only those elements, but also other elements not explicitly listed, or also includes elements inherent to such process, method, commodity or device. In the absence of more restrictions, the elements defined by the sentence “comprises a . . . ” do not exclude the existence of other identical elements in the process, method, commodity or device including the elements.

The above are only embodiments of the present application and are not intended to limit the present application. For those skilled in the art, the present application may have various modifications and variations. Any modification, equivalent substitution, improvement, etc. made within the spirit and principle of the present application should be included in the scope of the claims of the present application.

What is claimed is:

1. A method for testing audio spatial perception of a head-mounted display device, comprising:
wearing the head-mounted display device to be tested normally on a head of a simulated person, and controlling a virtual sound source by software instructions to be located in different preset spatial orientations in sequence;
controlling the virtual sound source to send an excitation signal at the preset spatial orientation and a speaker of the head-mounted display device to play the excitation signal, to obtain signals simultaneously received by left and right ears of the simulated person;
calculating multiple spatial sound effect parameters of the virtual sound source according to the signals simultaneously received by the left and right ears of the simulated person, wherein the spatial sound effect parameters comprise a interaural time difference, a interaural level difference and a spectrum curve after normalization of left ear/right ear transfer function; and
determining whether the calculated multiple spatial sound effect parameters are within respective preset standard value ranges corresponding to the preset spatial orientation; in response to that all the spatial sound effect parameters are within the respective preset standard value ranges, determining that a spatial sound effect test of the virtual sound source at the preset spatial orientation is qualified; in response to that a certain spatial sound effect parameter is not within the preset standard value range, determining that the spatial sound effect test of the virtual sound source at the preset spatial orientation is unqualified.

2. The method according to claim 1, wherein before the controlling the virtual sound source by software instructions to be located in different preset spatial orientations in sequence, the method further comprises:
in an anechoic chamber, by the simulated person and speakers, placing the speakers one by one at test points corresponding to each preset spatial orientation, and controlling the speakers to emit excitation signals at each test point, to obtain signals received simultaneously by the left and right ears of the simulated person; and
according to the signals simultaneously received by the left and right ears of the simulated person at each test point, predetermining standard value ranges of all the spatial sound effect parameters corresponding to each preset spatial orientation.

3. The method according to claim 2, wherein the calculating the interaural time difference of the virtual sound source according to the signals simultaneously received by the left and right ears of the simulated person comprises:
convolving the signals simultaneously received by the left and right ears of the simulated person with the excitation signal respectively, to obtain a time τ when the excitation signal reaches the left and right ears of the simulated person respectively; and
according to a time difference Δτ between the left and right ears, obtaining a interaural time difference of the virtual sound source.

4. The method according to claim 2, wherein the calculating the interaural level difference of the virtual sound source according to the signals simultaneously received by the left and right ears of the simulated person comprises:
converting the signals received simultaneously by the left and right ears of the simulated person into a frequency domain by fast Fourier transform (FFT) respectively, to obtain a frequency response (FR) of the signals received by the left and right ears; and
according to a difference ΔFR between the frequency responses of the signals received by the left and right ears, obtaining the interaural level difference of the virtual sound source.

5. The method according to claim 2, wherein the calculating the spectrum curve after normalization of left ear/right ear transfer function of the virtual sound source according to the signals simultaneously received by the left and right ears of the simulated person comprises:
converting the excitation signal and the signals simultaneously received by the left and right ears of the simulated person respectively into a frequency domain by FFT transformation;
in the frequency domain, dividing the signals received by the left and right ears by the excitation signal respectively, to obtain the spectrum curve of the left ear/right ear transfer function; and
normalizing the spectrum curve of the left ear/right ear transfer function at low frequency points respectively, to obtain the spectrum curve after normalization of left ear/right ear transfer function of the virtual sound source.

6. The method according to claim 1, wherein the determining whether the calculated multiple spatial sound effect parameters are within respective preset standard value ranges corresponding to the preset spatial orientation comprises:
finding a standard value range of the interaural time difference, a standard value range of the interaural level difference, and a standard value range of a spectrum amplitude of each left ear/right ear transfer function of the virtual sound source at the corresponding preset spatial orientation;
determining whether the calculated interaural time difference of the virtual sound source is within the preset standard value range of the interaural time difference; in response to that the calculated interaural time difference of the virtual sound source is within the preset standard value range of the interaural time difference, determining that the interaural time difference parameter is qualified; in response to that the calculated interaural time difference of the virtual sound source is not within the preset standard value range of the interaural time difference, determining that the interaural time difference parameter is unqualified;
determining whether the calculated interaural level difference of the virtual sound source is within the preset standard value range of the interaural level difference for each frequency point; in response to that the interaural level differences of all frequency points are within the standard value range, determining that the interaural level difference parameter is qualified; in response to that the interaural level difference of one frequency point is not within the standard value range, determining that the interaural level difference parameter is unqualified; and
for the calculated spectrum curve after normalization of the left ear/right ear transfer function of the virtual sound source, determining whether the spectrum amplitude is within the standard value range of the spectrum amplitude of the left ear/right ear transfer function for each frequency point; in response to that the spectrum amplitudes of the left ear/right ear transfer functions of all frequency points are within the standard value range, determining that the spectrum curve parameter of the left ear/right ear transfer function is qualified; in response to that the spectrum amplitude of the left ear/right ear transfer function of one frequency point is not within the standard value range, determining that the spectrum curve parameter of the left ear/right ear transfer function is unqualified.

7. The method according to claim 1, further comprising:
in response to that the spatial sound effect test of the virtual sound source at a certain preset spatial orientation is unqualified, ending the audio spatial perception test of the head-mounted display device, and outputting a result that the audio spatial perception test of the head-mounted display device is unqualified;
in response to that the spatial sound effect test of the virtual sound source at a certain preset spatial orientation is qualified, controlling the virtual sound source to change to another preset spatial orientation through software instructions, and then starting a new spatial sound effect test of the virtual sound source after the spatial position of the virtual sound source is changed; and
in response to that the spatial sound effect test of the virtual sound source at all preset spatial orientation is qualified, outputting a result that the audio spatial perception test of the head-mounted display device is qualified.

8. An apparatus for testing audio spatial perception of a head-mounted display device, comprising:
a spatial orientation control unit, configured to normally wear the head-mounted display device to be tested on a head of a simulated person, and control a virtual sound source to be located in different preset spatial orientations in sequence through software instructions;
a received signal acquisition unit, configured to control the virtual sound source to send an excitation signal at the preset spatial orientation and the speaker of the head-mounted display device to play the excitation signal, so as to acquire signals simultaneously received by the left and right ears of the simulated person;
a spatial sound effect parameter calculation unit, configured to calculate a plurality of spatial sound effect parameters of the virtual sound source according to the signals simultaneously received by the left and right ears of the simulated person, wherein the spatial sound effect parameters comprise a interaural time difference, a interaural level difference and a spectrum curve after normalization of left ear/right ear transfer function; and
a spatial sound effect parameter qualification determination unit, configured to determine whether the calculated multiple spatial sound effect parameters are within respective preset standard value ranges corresponding to the preset spatial orientation; in response to that all the spatial sound effect parameters are within the respective preset standard value ranges, determining that a spatial sound effect test of the virtual sound source at the preset spatial orientation is qualified; in response to that a certain spatial sound effect parameter is not within the preset standard value range, determining that the spatial sound effect test of the virtual sound source at the preset spatial orientation is unqualified.

9. The apparatus according to claim 8, wherein the spatial sound effect parameter qualification determination unit is configured for:
finding a standard value range of the interaural time difference, a standard value range of the interaural level difference, and a standard value range of a spectrum amplitude of each left ear/right ear transfer function of the virtual sound source at the corresponding preset spatial orientation;
determining whether the calculated interaural time difference of the virtual sound source is within the preset standard value range of the interaural time difference; in response to that the calculated interaural time difference of the virtual sound source is within the preset standard value range of the interaural time difference, determining that the interaural time difference parameter is qualified; in response to that the calculated interaural time difference of the virtual sound source is not within the preset standard value range of the interaural time difference, determining that the interaural time difference parameter is unqualified;
determining whether the calculated interaural level difference of the virtual sound source is within the preset standard value range of the interaural level difference for each frequency point; in response to that the interaural level differences of all frequency points are within the standard value range, determining that the interaural level difference parameter is qualified; in response to that the interaural level difference of one frequency point is not within the standard value range, determining that the interaural level difference parameter is unqualified; and
for the calculated spectrum curve after normalization of the left ear/right ear transfer function of the virtual sound source, determining whether the spectrum amplitude is within the standard value range of the spectrum amplitude of the left ear/right ear transfer function for each frequency point; in response to that the spectrum amplitudes of the left ear/right ear transfer functions of all frequency points are within the standard value range, determining that the spectrum curve parameter of the left ear/right ear transfer function is qualified; in response to that the spectrum amplitude of the left ear/right ear transfer function of one frequency point is not within the standard value range, determining that the spectrum curve parameter of the left ear/right ear transfer function is unqualified.

10. The apparatus according to claim 8, further comprising:
a test result output unit, configured for, in response to that the spatial sound effect test of the virtual sound source at a certain preset spatial orientation is unqualified, ending the audio spatial perception test of the head-mounted display device, and outputting a result that the audio spatial perception test of the head-mounted display device is unqualified; in response to that the spatial sound effect test of the virtual sound source at a certain preset spatial orientation is qualified, controlling the virtual sound source to change to another preset spatial orientation through software instructions, and then starting a new spatial sound effect test of the virtual sound source after the spatial position of the virtual sound source is changed; and in response to that the spatial sound effect test of the virtual sound source at all preset spatial orientation is qualified, outputting a result that the audio spatial perception test of the head-mounted display device is qualified.

11. A system for testing audio spatial perception of a head-mounted display device, comprising:
a simulated person;
a speaker;
a control console; and
a head-mounted display device to be tested;
wherein the control console uses the method for testing audio spatial perception of the head-mounted display device according to claim 1 to perform a spatial sound effect test on the head-mounted display device to be tested.
